(19) United States
(12) Patent Application Publication
(10) Pub. No.: US 2016/0216919 A1
(43) Pub. Date: Jul. 28, 2016

(54) Centralized Service of a Model Support for Printing Devices

(71) Applicant: KYOCERA Document Solutions Inc., Osaka (JP)

(72) Inventors: Oleg Y. Zakharov, Concord, CA (US); Tetsuji Yamaguchi, Concord, CA (US)

(21) Appl. No.: 14/602,932

(22) Filed: Jan. 22, 2015

(51) Int. Cl. G06F 3/12; G06K 15/00

(52) U.S. Cl. CPC G06F 3/1232; G06K 15/402; G06F 3/1204; G06F 3/1288; G06F 3/1291; G06F 3/1294

(57) ABSTRACT

Systems, apparatus, and methods for interfacing device management software and printing devices are provided. A computing device with device management software can send a discovery message requesting primary identification information to a printing device. The primary identification information can include a model name and a firmware version of the printing device. The computing device can receive the primary identification information from the printing device. The computing device can send a request message for model-dependent information based on the primary identification information to a server device. The computing device can receive a response to the request message from the server device that includes the model-dependent information. The computing device can generate a user interface (UI) display based on the model-dependent information in the response to the request message.

### BACKGROUND

Printing devices have increased in number and geographic footprint throughout the world and have become increasingly connected to networks. These networks can include a print server. Typically, when one or more documents and/or other print data are scheduled to be printed, the print data is either directly sent to one printing device, or sent to a print server.

If the print data is sent directly to one printing device, the printing device completes a print job for printing the print data. If the print data is sent to a print server, the print server selects one or more printing devices for the print job. Then, the print server sends the print data to the selected printing devices for printing. The selected printing devices print the print data and complete the print job.

The networks can include many printing devices. Some or all of the printing devices can have different features, functions, and capabilities. For example, some printing devices print in color, while others do not. As another example, some printing devices are equipped with duplexing hardware that allows printing on both sides of a sheet of paper, while other printing devices can only print on one side of a sheet of paper.

### SUMMARY

In a first aspect, a system is provided. The system includes a computing device and a server device. The computing device includes one or more processors and data storage. The data storage includes at least computer-readable instructions for device management software, that when the computer-readable instructions for the device management software are executed by the one or more processors of the computing device, cause the computing device to perform device-management functions. The device-management functions include: sending a discovery message requesting primary identification information to a printing device, where the primary identification information includes at least a model name of the printing device and a firmware version of the printing device; receiving, from the printing device, the primary identification information; and sending a request message for model-dependent information that is based on the primary identification information to the server device. The server device includes one or more processors and data storage. The data storage of the server device includes at least computer-readable instructions that when executed by the one or more processors of the server device, cause the server device to perform server-device functions. The server-device functions include: receiving the request message; and sending a response to the request message to the computing device. The device-management functions further include receiving the response to the request message and generating a display based on the response.

In another aspect, a method is provided. A computing device sends a discovery message requesting primary identification information to a printing device. The primary identification information includes a model name of the printing device and a firmware version for firmware of the printing device. The computing device receives the primary identification information from the printing device. The computing device sends a request message for model-dependent information that is based on the primary identification information to a server device. The computing device receives a response to the request message from the server device. The computing device generates a display based on the response to the request message.

In another aspect, an article of manufacture is provided. The article of manufacture includes computer-readable instructions that, when executed by one or more processors of a computing device cause the computing device to perform functions. The functions include: sending a discovery message to a printing device requesting primary identification information about the printing device, where the primary identification information includes a model name of the printing device and a firmware version for firmware of the printing device; receiving the primary identification information from the printing device; sending a request message for model-dependent information that is based on the primary identification information; receiving a response to the request message from the server device, and generating a display based on the response to the request message.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a diagram illustrating a printing system, according to an example embodiment.

FIG. 2A is a schematic block diagram illustrating a computing device, according to an example embodiment.

FIG. 2B is a schematic block diagram illustrating a network connecting a device manager and a plurality of printing devices, according to an example embodiment.

FIG. 2C is a schematic block diagram illustrating a network connecting a device manager and a server, according to an example embodiment.

FIGS. 3A and 3B illustrate an example user interface associated with a device manager, according to an example embodiment.

FIG. 4 is a diagram illustrating a method, according to an example embodiment.

FIG. 5 shows a scenario for rendering function lists associated with a printing device, according to an example embodiment.

FIG. 6 shows a device settings dialog, according to an example embodiment.

FIG. 7 shows example nation-specific and international device settings dialogs, according to an example embodiment.

FIG. 8 shows a flowchart for a method, according to an example embodiment.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

I. Overview

The present application relates generally to device management software that interfaces with printing devices. An example modern printing system includes a group of computers that can send print data to one or more specified printing devices in the printing system. In some printing systems, some or all of the printing devices in the printing system are manufactured by different manufacturers, have specific model numbers, and/or support specific sets of features and executable commands.

A device manager, which can be one or more computing devices executing device management software, can be used to manage the printing devices. The device manager can obtain information about the printing devices and send maintenance, configuration, and other commands/data to the printing device as part of printing device management. The device manager can store information about the printing devices. The information can include primary identification information to identify specific printing devices and model-dependent information to identify features of specific printing devices. The primary identification information can include information about features, functions, and other information for the specific printing device. For example, the device management software can store model-dependent information about available functions of a printing device in a data structure such as a function table, and link the model-dependent information to a model table and/or other data structure to provide a model dependent list.

A central server can communicate with device manager(s) executing device management software to provide a list of available functions for printing devices based on primary identification characteristics for the printing device; e.g., manufacturer name, model name, firmware version, device serial number and geographical region of device operation. The primary identification characteristics can be used to uniquely map or link a printing device to a set of available functions.

The set of available functions for a printing device can include device status monitoring functions and device configuration functions. Device status monitoring functions can include functions for gathering device status information, such as, but not limited to, device counters, toner levels, and error codes. Device configuration functions can include functions for reviewing and/or changing specific parameters for a printing device, such as, but not limited to, fan mode parameters, FAX parameters, and memory parameters etc. In some cases, the available monitoring and configuration functions of a printing device can depend on a manufacturer, a device model, and/or a firmware version of the printing device. For example, configuration parameters for a fan mode could be available only on certain models of printing devices made by a particular manufacturer and not available on other models of printing devices made by the particular manufacturer.

Printing devices that are located on a network can be managed by the device management software using a network communication protocol; e.g., Simple Network Management Protocol (SNMP). A printing device can execute firmware that includes a communication module, which can be configured to interact with the device management software via an Application Programming Interface (API) utilizing communication protocols such as HyperText Transport Protocol (HTTP), Simple Mail Transport Protocol (SMTP), and other communication protocols.

Each version of firmware for a printing device can provide a set of specific features and/or an API for the printing device. Once device management software of a device manager establishes network communication with a printing device, a listing of the set of available functions of the printing device can be rendered or populated using a user interface (UI) of the device manager. This listing can be based on the primary identification characteristics for the printing device, as mentioned above.

II. System Examples

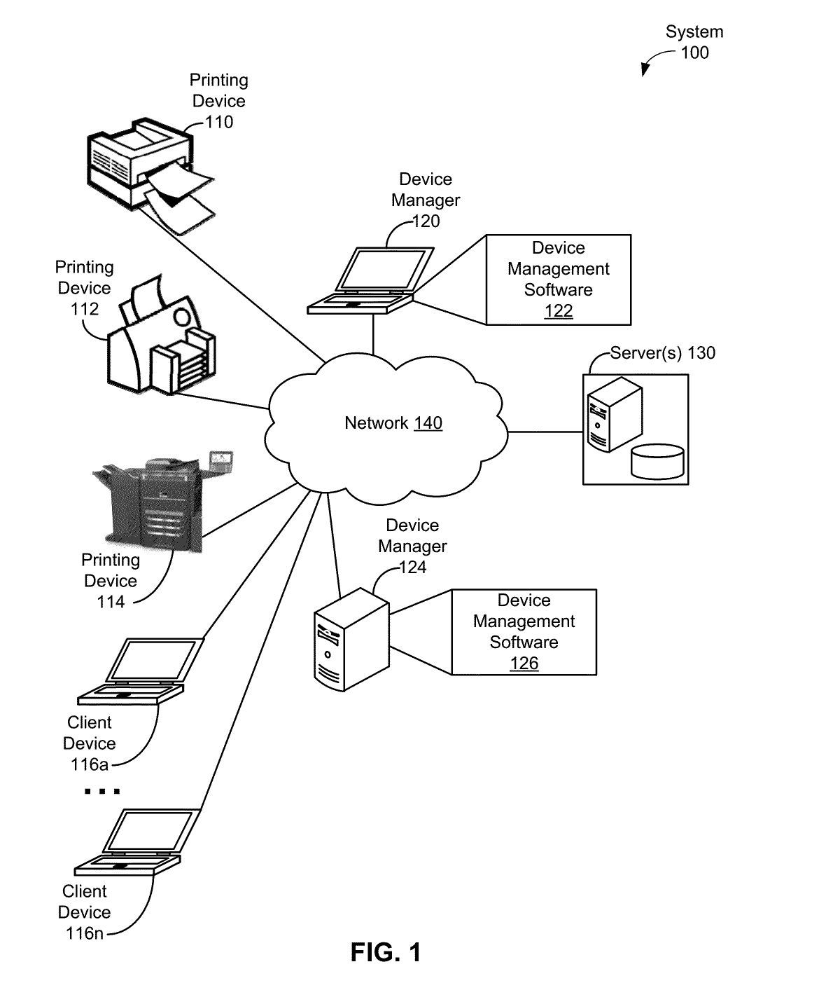

FIG. 1 is a diagram illustrating printing system 100, according to an example embodiment. Printing system 100 includes printing devices 110, 112, 114, client devices 116a . . . 116n, device managers 120, 124, and one or more servers 130 interconnected using network 140. In some examples, system 100 can have more, fewer, and/or different types of client devices, device managers, and/or printing devices than indicated in FIG. 1

In an example embodiment, some or all printing devices 110, 112, 114 can be connected to some or all client devices 116a-116n through one or more, possibly different, network protocols. Data can be transmitted between printing devices 110, 112, 114, client devices 116a-116n, device managers 120, 124, and server(s) 130 over wired and/or wireless links between client devices, device managers, printing devices, servers and network 140. The format of each respective data transmission between devices in system 100 can include one or more of a variety of different formats including: text formats, image formats, extensible mark-up language (XML), database tables, or another original or flat file format.

Communications between the client devices, device managers, servers, and printing devices can include: client devices 116a-116n, device managers 120, 124, and/or server(s) 130 sending data for print jobs and/or print job portions to printing devices 110, 112, 114 for printing and printing devices 120a-120g sending alert, status, error, and/or other messages to client devices 116a-116n, device managers 120, 124, and/or server(s) 130 to inform other devices about error or other conditions of the printing devices; e.g., idle, printing, sleeping, paper jam, low or out of paper, low or out of toner/ink, etc. Other communications between one or more client devices, one or more device managers, one or more servers, and one or more printing devices are possible as well.

As indicated in FIG. 1, device manager 120 can execute device management software 122 and device manager 124 can execute device management software 126. Device management software 122, 126 can be configured to perform herein-described device management functions for managing printing devices, such as printing devices 110, 112, 114. In some embodiments, device management software 122 can have the same functionality as device management software 126.

One or more servers 130 can be configured to store data related to printing devices, such as primary identification characteristics and/or model-dependent information, and provide some or all of that data upon request. For example, a device manager, such as device manager 120 and/or 124, can formulate a query with primary identification characteristics for a printing device, such as printing device 110, 112, or 114, and send the query to server(s) 130. Server(s) 130 can respond to the query with a response that includes model-dependent information for a printing device corresponding to the primary identification characteristics submitted in the query. Server(s) 130 can perform other functions as well.

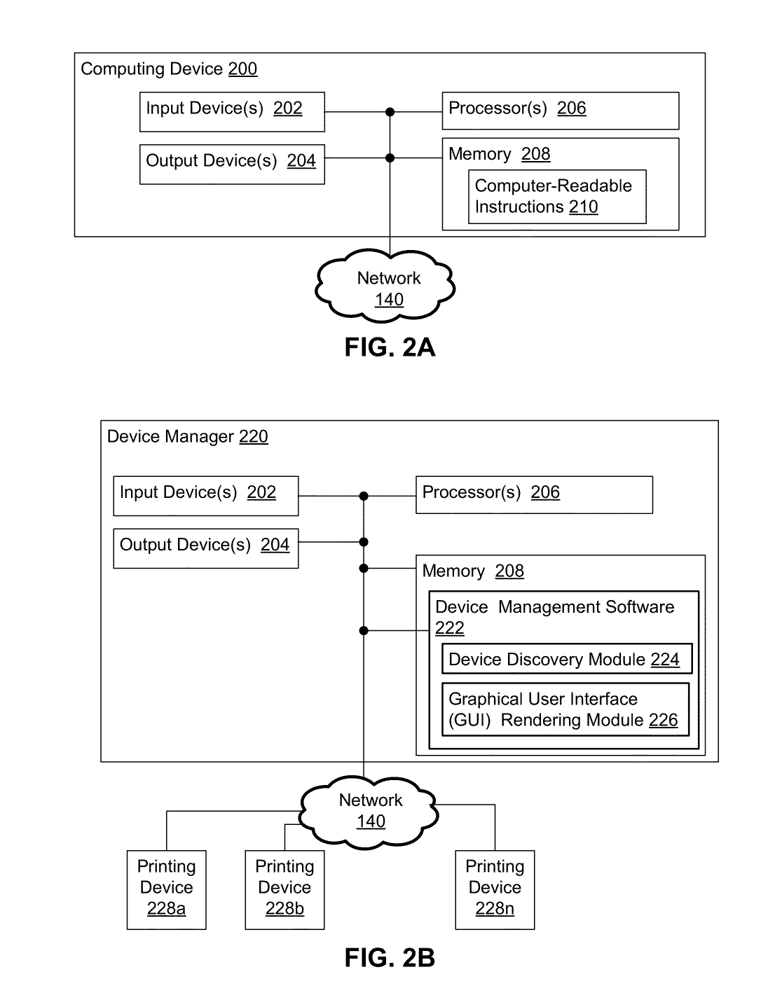

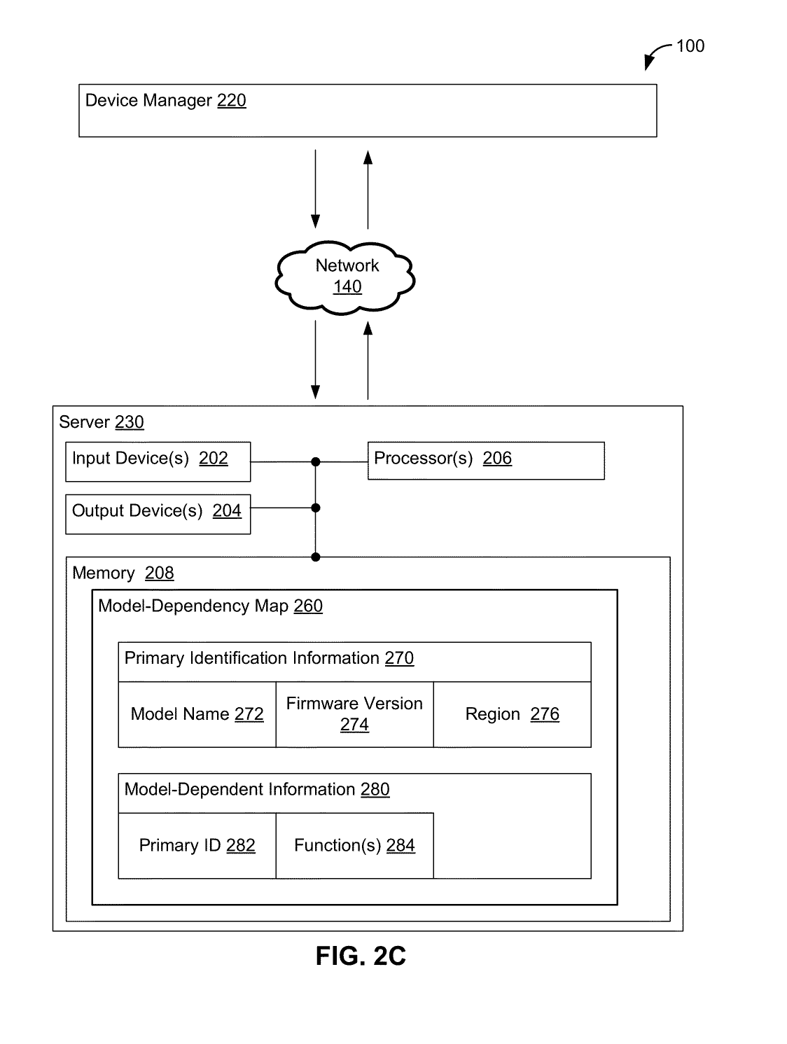

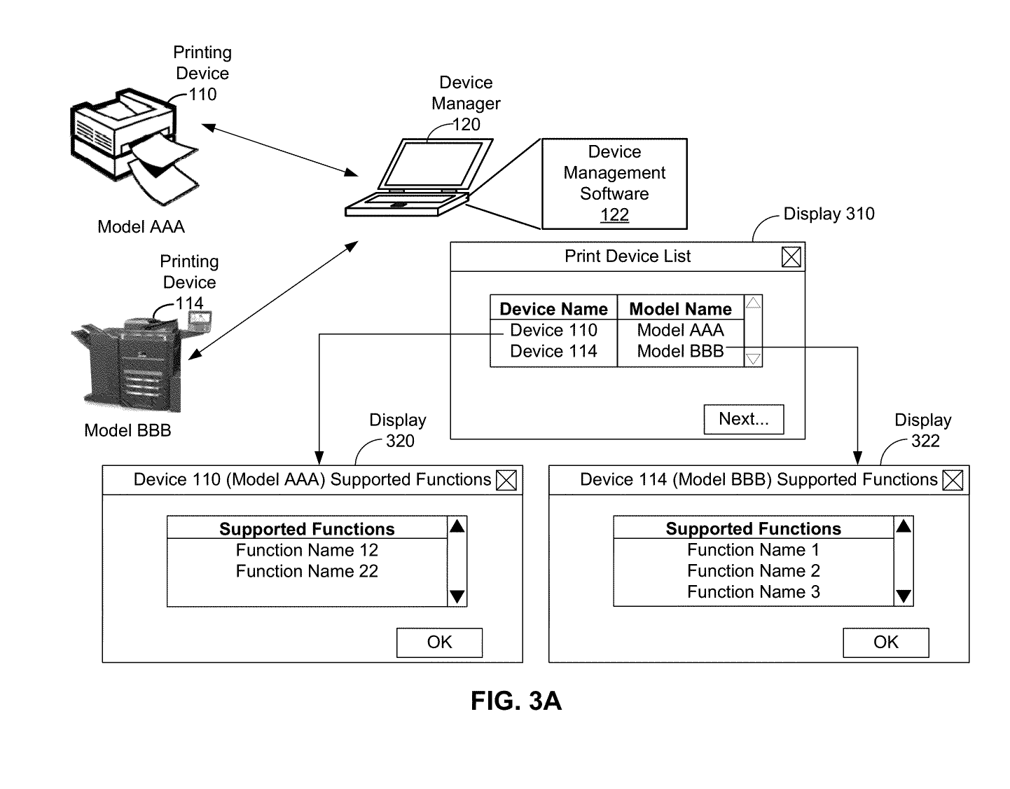

FIG. 2A is a schematic block diagram illustrating computing device 200, according to an example embodiment. In some embodiments, computing device 200 can be configured to perform one or more herein-described functions of printing devices 110, 112, 114, 228a-228n, client devices 116a-116n, device managers 120, 124, 220, device management software 122, 126, server(s) 130, 230, methods 400 and 800, UI displays 610, 710, and 760 and/or herein-described functionality related to scenario 500.

Computing device 200 can include one or more input devices 202, one or more output devices 204, one or more processors 206 and memory 208. Input devices 202 can include user input devices, network input devices, sensors, and/or other types of input devices. For example, input devices 202 can include user input devices such as a touch screen, a keyboard, a keypad, a computer mouse, a track ball, a joystick, a camera, a voice recognition module, and/or other similar devices. Network input devices can include wired network receivers and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of network 140, and/or wireless network receivers and/or transceivers, such as a Bluetooth transceiver, a Zigbee transceiver, a Wi-Fi transceiver, a WiMAX transceiver, a wireless wide-area network (WWAN) transceiver and/or other similar types of wireless transceivers configurable to communicate via a wireless network, such as wireless portions of network 140. Sensors can include devices configured to measure conditions in an environment of computing device 200 and provide data about that environment, such data including, but not limited to, location data, velocity (speed, direction) data, acceleration data, and other data about the environment for computing device 200. Example sensors include, but are not limited to, GPS sensor(s), location sensors(s), gyroscope(s), accelerometer(s), magnetometer(s), camera(s), light sensor(s), infrared sensor(s), and microphone(s). Other input devices 202 are possible as well.

Output devices 204 can include user display devices, audible output devices, network output devices, and/or other types of output devices. User display devices can include one or more printing components, liquid crystal displays (LCD), light emitting diodes (LEDs), lasers, displays using digital light processing (DLP) technology, cathode ray tubes (CRT), light bulbs, and/or other similar devices. Audible output devices can include a speaker, speaker jack, audio output port, audio output device, headphones, earphones, and/or other similar devices. Network output devices can include wired network transmitters and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of network 140, and/or wireless network transmitters and/or transceivers, such as a Bluetooth transceiver, a Zigbee transceiver, a Wi-Fi transceiver, a WiMAX transceiver, a wireless wide-area network (WWAN) transceiver and/or other similar types of wireless transceivers configurable to communicate via a wireless network, such as wireless portions of network 140. Other types of output devices can include, but are not limited to, vibration devices, haptic feedback devices, and non-visible light emission devices; e.g., devices that emit infra-red or ultra-violet light. Other output devices 204 are possible as well.

Processors 206 can include one or more general purpose processors, central processing units (CPUs), CPU cores, and/or one or more special purpose processors (e.g., graphics processing units (GPUs), digital signal processors (DSPs), field programmable gated arrays (FPGAs), application specific integrated circuits (ASICs), etc.). Processors 206 can be configured to execute computer-readable program instructions 210 that are contained in memory 208 and/or other instructions as described herein.

Memory 208 can be non-transitory machine-readable storage configured to store data and/or instructions. In particular, memory 208 can store machine-readable instructions 210 that, when executed by processor(s) 206, can cause a computing device to perform functions, such as but not limited to, functions of herein-described devices, networks, methods, features, and scenarios.

FIG. 2B is a schematic block diagram illustrating network 140 connecting device manager 220 and a plurality of printing devices 228a, 228b . . . 229n, according to an example embodiment. Device manager 220 can be utilized to perform the tasks of a herein-described device manager, such as device manager 120 or 124.

Device manager 220 is an example of computing device 200 having input devices 202, output devices 204, processors 206, and memory 208. Memory 208 of device manager 220 stores machine-readable instructions and/or data, such as, but not limited to device management software 222. In some embodiments, a smaller or larger plurality of printing devices can be connected to network 140, and therefore to device manager 220, than shown in FIG. 2B.

FIG. 2B shows that device management software 222 can include at least device discovery module 224 and graphical user interface (GUI) rendering module 226. Device discovery module 224 can be configured to generate and send a discovery message to one of printing devices 228a, 228b . . . 228n. The discovery message can request primary identification information from the printing device, such as printing device manufacturer, printing device model, printing device firmware information, region (or market) information for the printing device, and/or other information related to identifying a printing device. The printing device can respond to the discovery message with the requested primary identification information. Device discovery module 224 can receive the response from the printing device with the primary identification information.

Upon reception of the primary identification information, device discovery module 224 can store, communicate, and/or process information about the printing device, including but not limited to, the primary identification information. For example, device discovery module 224 can generate and send a request message to obtain model-dependent information about the printing device. The request message can include the primary identification information to identify what model-dependent information is requested by device discovery module 224.

Device discovery module 224 can send the request message to server(s) 130, which can send a response to the request message to device manager 220. Upon reception of the response to the request message, device discovery module 224 can retrieve model-dependent information from the response to the request message and store, communicate, and/or process information about the printing device, including but not limited to, the model-dependent information. For example, the primary identification information and model-dependent information can be stored in a map (or other data structure) relating the primary identification information to the model-dependent information.

As another example, GUI rendering module 226 can generate a display that includes primary identification information and/or model-dependent information about printing devices. In some embodiments, GUI rendering module 226 can be configured to display attributes about a number of printing devices on the display, such as names and/or other identifiers, allow selection of a displayed printing device via the display, and, upon such selection, render and show primary identification information and/or model-dependent information about the selected printing device via the display. Many other examples of use of primary identification information and/or model-dependent information by device manager 220 are possible as well.

FIG. 2C is a schematic block diagram illustrating network 140 connecting device manager 220 and server 230, according to an example embodiment. Server 230 can be utilized to perform the tasks of a herein-described server, server device, and/or central server, such as one of server(s) 130.

Server 230 is an example of computing device 200 having input devices 202, output devices 204, processors 206, and memory 208. Memory 208 of server 230 stores machine-readable instructions and/or data, such as, but not limited to software and data related to model-dependency map 260. In some embodiments, a smaller or larger plurality of device managers and servers can be connected to network 140 than shown in FIG. 2C.

Model-dependency map 260 can be a software system that provides information about functions of printing devices based on pre-defined primary characteristics of the printing devices. That is, the model-dependency map can relate primary identification information, such as printing device model, printing device firmware version, and market region data, to model-dependent information, such as a specific set of device model-dependent functions.

FIG. 2C shows that model-dependency map 260 stored in memory 208 of server 230 includes primary identification information 270 and model-dependent information 280. A device, such as server(s) 130, supporting model-dependency map 260 can use manual, semi-automatic, and/or automatic techniques to maintain and store changes to model-dependent information. Any devices or application can share information to update a model-dependency map or to insert a new entity based on existing primary identification information, where the new entity can define model-dependent information; e.g., a list of available functions.

Primary identification information 270 includes model-name 272, firmware version 274, and region 276. Model name 272 can specify manufacturer and/or model names of a printing device; e.g., Kyocera ECOSYS FS-C8650DN Color Network Laser Printer, Kyocera FS-C8650DN, FS-C8650SN. Firmware version 274 can include information identifying a release, build, and/or version of firmware for the printing device; e.g., Version 1, Initial Release, Build 172.13345. Region 276 can include geographical region (or market) information about a geographical region (or market) where a printing device is being utilized; e.g., Asia-Pacific, Japan, North America, French language market.

Model-dependent information 280 can include a primary identifier (ID) 282 and one or more functions 284. Primary identifier 282 can include some or all of primary identification information 270 and/or a representation of some or all of primary identification information 270; e.g., a hash value calculated based on some or all of primary identification information 270. For example, primary identifier 282 can be “Kyocera Mita FS1020D 154.08 A011 IB-21E 1.4.0” that identifies a printing device manufacturer (Kyocera), model name (Mita FS1020D), and firmware version information (154.08 A011 IB-21E 1.4.0). Many other primary identifiers are possible as well.

Function(s) 284 can include information about one or more functions for a printing device identified using primary identifier 282. For example, function(s) 284 associated with primary identifier 282 of “Kyocera Mita FS1020D 154.08 A011 IB-21E 1.4.0” can include functions indicating the printing device is a laser printer, has a USB network interface, prints in black and white, utilizes toner, can be configured with a 250 sheet print tray, prints in either simplex or duplex, and prints up to 20 pages per minute. Many other function(s) 284 are possible as well.

III. Device Management Software with Model-Dependent Information

Device management software 222 can operate with printing devices via network(s), such as shown in printing system 100 of FIG. 1, to perform at least three operations.

Operation 1: Device management software 222 can discover printing devices on a network, gather initial device identification information, and populate a list of the devices for possible display. Device management software 222 can connect to network-available printing devices and gather primary identification information for these devices. Listing of the network-available printing devices and primary identification information can be rendered using a software UI module of the device manager; e.g., GUI rendering module 226 of device management software 222.

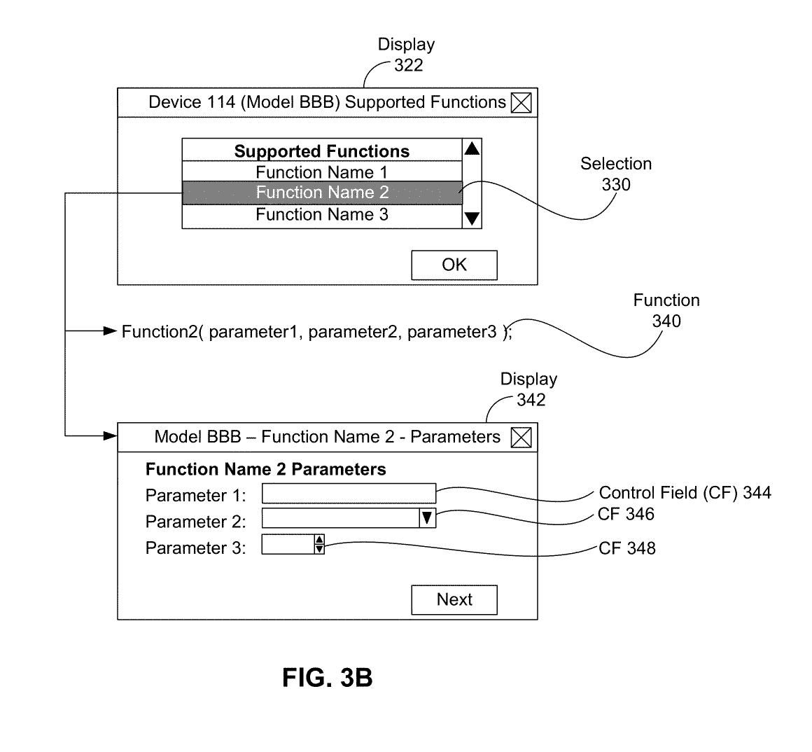

FIG. 3A illustrates an example user interface associated with device manager 120, according to an example embodiment. As part of system 100, device manager 120 connects to at least printing devices 110 and 114 via network 140. Device manager 120 executes device management software 122, which is configured; e.g., using GUI rendering module 226 to generate user interfaces related to discovered printing devices. In the example shown in FIG. 3A, device manager 120 has discovered at least printing devices 110 and 114, where printing device 110 is a “Model AAA” printing device and printing device 114 is a “Model BBB” printing device.

After discovering printing devices 110 and 114 and obtaining primary identification information about these devices, device management software 122 of device manager 120 can display a list of discovered devices, such as the “Print Device List” display 310 shown in FIG. 3A. Display 310 lists devices by name and model—as shown in FIG. 3A, printing devices 110 and 114 are shown in display 310 with respective device names of “Device 110” and “Device 114” and respective model names of “Model AAA” and “Model BBB”. For example, device management software 122 can have a user interface element, such as an icon, button, or other control, that when selected, instructs device management software 122 to generate and show display 310.

Operation 2: A UI of the device management software can render a listing of the set of available functions of the printing device; e.g., the UI can be rendered by GUI rendering module 226 of device management software 222. When a user selects a specific printing device by using the UI, then the device management software can identify what functions would be available for the selected printing device.

Device management software 122 can also determine, perhaps via locally stored data or via a server such as server(s) 130, model-specific information. Device management software 122 of device manager 120 can display a list of model-specific information, such as supported functions, for a discovered printing device. For example, FIG. 3A shows display 320 listing supported functions for printing device 110, where the supported functions include “Function Name 12” and “Function Name 22”. FIG. 3A also shows display 322 listing supported functions for printing device 114, where the supported functions include “Function Name 1”, “Function Name 2”, and “Function Name 3”. As indicated, a display of supported functions, such as display 320 or 322, can be generated and displayed upon selection of a printing device shown on display 310.

Operation 3: The device management software can render a list of parameters for each function in the set of available functions. In some cases a function has parameters; e.g., the pseudo-code for a function “Function2” with three parameters can be:

Function2(parameter1, parameter2, parameter3);

where the parameters can differ for each function. The UI of the device management software; e.g., GUI rendering module 226 of device management software 222 can render fields for entering and displaying values of these parameters.

Each parameter of the function can have restrictions or/and validation rules. Restrictions can include data type restrictions (e.g., string or digits), value range restrictions (e.g., how long, how big), and/or other restrictions. Validation rules are very similar to restrictions but can include rules when parameters are dependent on each other; e.g., if parameter 1 has a value of “A”, then parameter 2 can take the range of values 1-3.

The functions and/or parameters can vary based on primary identification information; that is, functions and/or parameters can vary between manufacturers, printing device models, markets/regions, and/or firmware versions. For example, a printer made by Manufacturer A can have a function that is not present on Manufacturer B's printers (or vice versa). As another example, two models of printing devices made by the same manufacturer can have different functions and/or parameters; for example, one model; e.g., the “Deluxe” model made by Manufacturer B can have functions not present on the “Economy” model made by the same manufacturer (or vice versa). Different regions and markets can have different functions as well; e.g. functions related to different supported languages, paper sizes, character encodings (e.g., ASCII, Unicode, etc.), electrical characteristics, etc.

Further, each firmware (and perhaps other printing device software) release can add, delete, and/or change features, functions, and/or parameters on the printing device. For example, if a firmware release with version number “1.0” for a specific printing device does not support printing at more than 300 dots per inch (DPI), but a later firmware release with version number “2.0” for the specific printing device can support 300 (or more) DPI, then values of parameters and related functionality based on a specified maximum DPI for the specific printing device would differ based on which version of firmware is being used by the printing device. Many other examples of differing features, functions, and parameter values based on differing primary identification characteristics are possible as well.

FIG. 3B illustrates an example user interface associated with device manager 220, according to an example embodiment. In particular, FIG. 3B shows an example for a selected function “Function Name 2” of printing device 114, where the function is selected via display 322 discussed above in the context of FIG. 3A. In the illustrated example, selection 330 of function “Function Name 2” is made using display 322.

Continuing this example, Function Name 2 has pseudo-code as indicated above and as function 340; e.g., function2(parameter1, parameter2, and parameter3). Once Function Name 2 has been selected, a GUI of device manager 220; e.g., a GUI rendered and controlled by GUI rendering module 226 of device management software 222, can generate display 342 for setting, reviewing, and/or changing values of the three parameters of “Function Name 2” for a “Model BBB” printing device; e.g., the model name of previously-selected printing device 114. Display 342 includes control fields (CF) 344, 346, and 348 for reviewing and/or controlling values of respective parameters Parameter 1, Parameter 2, and Parameter 3 of Function Name 2.

IV. Approaches for Obtaining Model-Dependent Information Using Device Management Software

Several approaches can be utilized to obtain model-dependent information, such as information about available functions for a printing device:

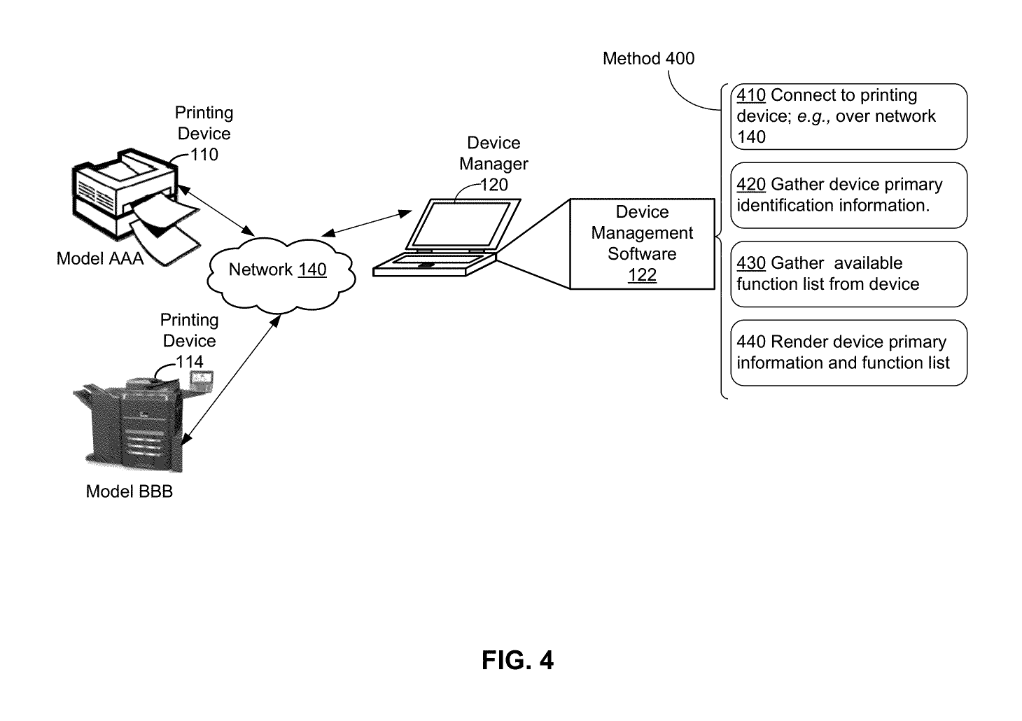

1. The printing device can provide model-dependent information about its own available functions. A device manager (or other computing device) can use method 400 shown in FIG. 4 to gather all needed information about available devices on a network.

Method 400 can begin at block 410, where the device manager can connect to printing devices; e.g., device manager 120 of system 100 can connect to at least printing devices 110 and 114 as illustrated in FIG. 4.

Then, at block 420, the device manager can send a request for model-dependent information (and perhaps primary identification information) to each printing device connected to and/or being managed by the device manager; e.g., device manager 120 of system 100 can send requests to at least printing devices 110 and 114 as illustrated in FIG. 4.

At block 430, the device manager can receive responses with at least the requested model-dependent information from the printing devices connected to and/or being managed by the device manager. In some embodiments, each printing device can support a common, consistent API to request and/or provide the model-dependent information; e.g., to expose one or more function lists of a printing device.

At block 440, the device manager or other computing device can render model-dependent information, such as the above-mentioned function list, using a UI. For example, device management software 122 of device manager 120 can use a GUI rendering module, such as GUI rendering module 226 to render the model-dependent information.

Under this approach, each printing device utilizes resources for providing model-dependent information, such as memory for storing model-dependent information, bandwidth and/or storage for providing at least some model-dependent information with firmware versions, and software for data storage and API support to provide model-dependent information. Further, device management software needs software and resources to generate and send requests to printing devices; e.g., prior to rendering a function list and/or other model-dependent information for a printing device, the device management software can request model-dependent information from the printing device. In particular cases, the device management software can cache/store model-dependent information after the information has been requested and obtained from printing devices.

2. The device management software of the device manager can store model-dependent information. For example, the device management software can store model-dependent information for each device model managed by the device manager.

This approach can involve each instance of device management software maintaining up-to-date model-dependent information for at least all models of printing devices managed by device management software. The up-to-date model-dependent information can then be distributed across all running instances of device management software applications. Further, each instance of device management software has to be upgraded when new printing models appear on a market, because the device management software will not have information about the new printing models unless this information is distributed to the instances of device management software.

3. A dedicated server, such as server(s) 130 of system 100, can provide a service to provide model-dependent information about printing devices to all interested application. The server can use an application that maintains model-dependent information for all existing printing devices, and can be updated as new models come into the market and for other changes to model-dependent information; e.g., server(s) 130 can maintain model-dependency map 260. Then, device management software, and perhaps other applications, can obtain model-dependent information from the server as soon as the model-dependent information is made available by the server. For example, the server can receive queries from device management software, and perhaps other applications, requesting model-dependent information based on primary identification information provided as part of the queries, and can responsively send responses to the queries with the requested model-dependent information (or an error indication that the query somehow cannot be satisfied).

The server can store the model-dependent information in one or more data structures, such as herein-described model-dependency map 260, which can be (part of) a software system that provides information about functions of printing device based on pre-defined primary characteristics of the printing device. That is, the model-dependency map can relate primary identification information, such as printing device model, printing device firmware version, and market region data, to model-dependent information, such as a specific set of device model-dependent functions.

A new entity in the model-dependency map can be based on one or more data items of primary identification information. The market region can be used to indicate how internationalization extends functions for the printing device. Model-dependent information can depend on hardware configuration options of the printing device, where the hardware configuration specifies optionally-installed equipment; e.g., how many paper trays are installed, a type of control panel on the printing device, etc. In some cases, a model-dependent function also introduces an additional level of model dependency in terms of a specific range of accepted data, for instance: a range of possible installed memory cards could vary depending on a primary identification characteristic.

There are several primary identification characteristics (input parameters) to be passed to a model-dependency map to read back information about supported model-dependent functions. The model-dependency map can include a list of available markets, models, and versions of firmware for printing devices linked to available functions and parameters that a specific printing device supports. The model-dependency map can store variables including a device model variable, a firmware version variable, and perhaps other variables. Many optional functions and respective variables of the optional functions can be determined based on a version of firmware running on a printing device; e.g., information about optional functions can be determined based on a value of the firmware version.

For example, suppose firmware version 1 of a printing device PD1 supports functions f1, f2, and f3, while firmware version 2 of PD1 supports functions f1_prime, f2, f4, and f5, where f1_prime is a modified version of function f1, where function f1 is associated with a variable V1 whose value is 1, and where function f1_prime is associated with a variable V1 whose value is 10. Then, by knowing the firmware version of PD1, it can be determined whether optional functions f3, f4, and f5 are supported by PD1, and whether a value of V1 of either 1 or 10 is associated with PD1.

A server, such as server(s) 130, can maintain the model-dependency map, such as model-dependency map 260, in a centralized fashion. Device management software, such as device management software 222, can communicate with the server and use the model-dependency map to populate a UI display of model-dependent features that belong to a specific printing device. Software applications and/or users that manage printing devices can use the model-dependency map for: tracking printer device functions, configuration and deployment of printer drivers, management and maintenance of a number of printing devices, and centralized network management, collection of business-related information from devices (number of printed pages, amount of toner that has been spent by a specific device), providing information about printing device features and components, cataloging primary characteristics and secondary functions (or features) of printing devices, and perhaps other uses.

One example of model-dependent information is configuration-related information. A printing device can be managed in a specific mode; e.g., a “maintenance mode”. While in the specific mode, the printing device can support a set of commands or operations that permit changes to configuration settings and/or states of the printing device. One example of a configuration setting is a number of sheets that can be printed from one occurrence of toner and one example of a configuration state is initializing a hard disk (or other memory device) associated with the printing device. Many other examples of configuration settings and states are possible as well.

In practice, not all configuration settings and states are available for all printing devices. That is, specific configuration settings and states vary and/or are unavailable (or are available) depending on printing device primary identification information, such as printing device model. Then, in the context of a model-dependency map, maintenance-mode units, such as configuration settings and states, are examples of model-dependent features.

Another example of model-dependent information is information related to API(s) supported by a printing device that allow support for integration with systems external to the printing device. For example, printing-related parameters, such as an ink drop size, can be specified via API for some printing devices. As another example, error reporting and/or error codes can be part of an API for other printing devices.

As an example for API/software integration with the model-dependency map, a software application can have functions f1, f2 . . . used to communicate with and manage a printing device. The software application can query the model-dependency map to learn availability of functions on the printing device that the software application utilizes to interface with the printing device. An example pseudo code syntax for checking availability of functions on the printing device is

bool availability=current_printing_device.IsAvailable(“function_code”);

where current_printing_device is a representation of an instance of an object representing a printing device, and function_code is a representation of one or more functions, features, and/or settings supported by the printing device.

In some embodiments, a device manager can keep a list of all available functions, features, and settings; however, these lists may be duplicated by each device manager. To avoid this data duplication, the central server can keep such a list; e.g., as part of model-dependent information in a model-dependency map. Communication between a device manager executing a device management software and the central server can utilize one or more network protocols; e.g., SNMP, HTTP.

In a scenario where device management software attempts to utilize available functions, features, and settings of a printing device, an initial communication between device management software and the printing device can gather primary identification information from the printing device. Then, the device management software can formulate a query to the central server with the primary identification information. The central server can use the primary identification information in the query to search for model-dependent information, such as available functions, features, and settings, in the model-dependency map. Then, the central server can generate a response to the query with the available functions, features, and settings retrieved from the model-dependency map and send the response to the device management software.

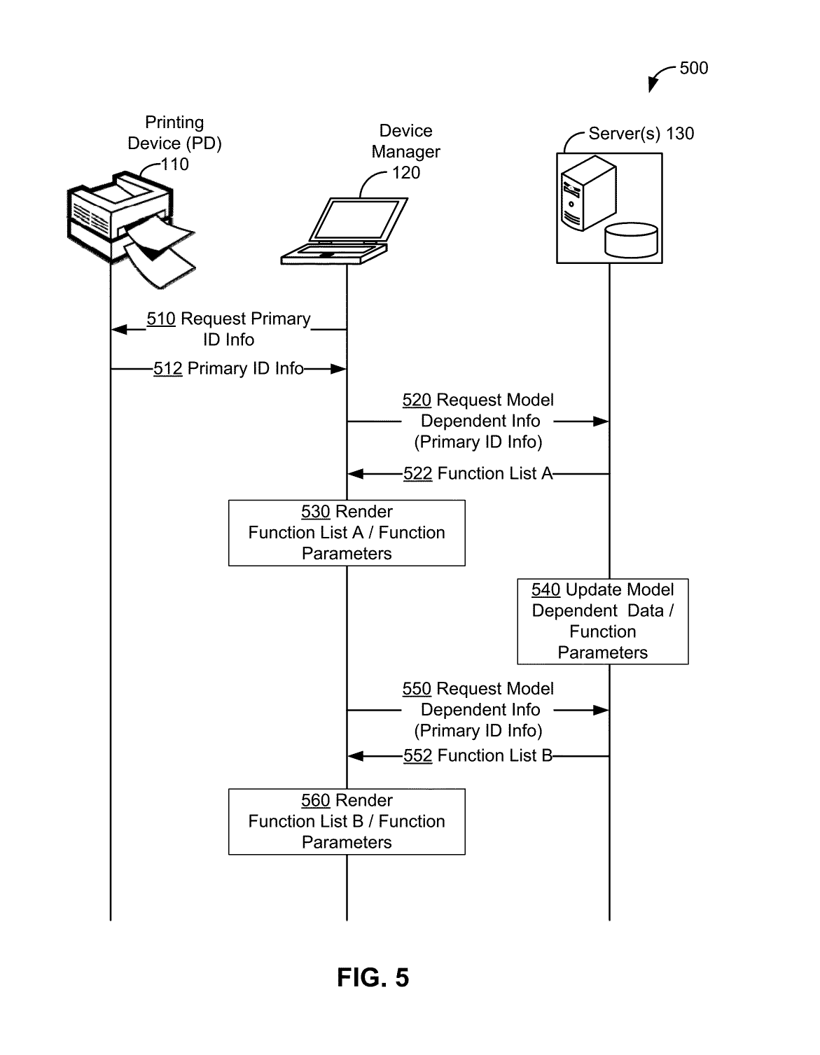

FIG. 5 shows scenario 500 for rendering function lists associated with a printing device, according to an example embodiment. Scenario 500 shows a sequence of communication between printing device 110, device manager 120 executing device management software 122, and server(s) 130 of system 100.

Scenario 500 begins with device manager 120 sending request 510 to printing device 110 for primary identification information. In response to request 510, printing device 110 can send message 512 with primary identification information that identifies the printing device; e.g., manufacturer name, model name, firmware version, market/geographic region, and/or other information for printing device 110.

Scenario 500 continues with device manager 120 generating request 520 to obtain model-dependent information about printing device 110, such as a function list, based on the primary identification information provided in message 512. After generating request 520 based on the primary identification information, device manager 120 sends request 520 to server(s) 130. Server(s) 130 obtain primary identification information from request 520, query a model-dependency map, such as model-dependency map 260, using the obtained primary identification information as key information, and receive a query response from the map with model-dependent information for printing devices having the primary identification information. In scenario 500, server(s) 130 respond to request 520 by generating and sending message 522 with “Function List A” (the requested model-dependent information about printing device 110) to device manager 120.

After receiving message 522, device manager 120 can obtain the function list Function List A from message 522. At block 530, device manager 120 can render data from Function List A, such as function names and parameters, as (part of) a display about functions of printing device 110; e.g., device manager 120 can render and show display 320 of FIG. 3A.

Scenario 500 continues at block 540 with server(s) 130 updating model-dependent data, including function parameters for printing device 110. After server(s) 130 update the model-dependent data, scenario 500 continues with device manager 120 generating request 550 to obtain up-to-date model-dependent information about printing device 110 based on the primary identification information provided in message 512 and stored by device manager 120 (or in other scenarios, the primary identification information can be re-requested by device manager 120 from printing device 110). After generating request 550, device manager 120 sends request 550 to server(s) 130. Server(s) 130 obtain primary identification information from request 550 and use the primary identification information to receive up-to-date model-dependent information for printing devices having the primary identification information from the model-dependency map, as discussed above in the context of request 520 and message 522. In scenario 500, server(s) 130 respond to request 550 by generating and sending message 552 with “Function List B” (the requested up-to-date model-dependent information about printing device 110) to device manager 120.

After receiving message 552, device manager 120 can obtain the function list Function List B from message 552. At block 560, device manager 120 can render data from Function List B, such as up-to-date function names and parameters, as (part of) a display about functions of printing device 110; e.g., device manager 120 can render and show an updated version of display 320 of FIG. 3A. After completing block 560, scenario 500 can be completed.

In some scenarios, the device management software can download some model-dependent information as a local model-dependent map from the central server on a periodic basis (e.g., once a day, twice a month, every two months), on demand (e.g., via GUI and/or command), and/or in response to other conditions (e.g., a new printing device being discovered by the device management software). The downloaded local model-dependent map can be in one or more formats, such as an eXtended Markup Language (XML) format, a JavaScript Object Notation (JSON) object, a key-value list, or some other format. The local model-dependent map can catalog a detailed list of functions and parameters and can be utilized by device management software to manage printing devices; e.g., via one or more user interfaces.

The central server can provide part or the entire model-dependent map to device management software via one or more networks, such as the Internet. Then, as indicated above, device management software can be configured to automatically download local model-dependent maps from the central server. A printing device manufacturer can update portions of the model-dependent map related to printing devices made by the printing device manufacturer in a timely manner. Further, the printing device manufacturer can use the model-dependent map to provide information about a new and/or upcoming model of a new printing device ahead of its release date.

The model-dependent map can be managed by printing device manufacturers as indicated above and/or by other entities, which can provide information to the model-dependent map and/or central server via a public API. The public API can be used to build integrated solutions by independent printing device vendors. A content management system can be used to maintain the public API to enable support for model-dependent information of external applications, such as but not limited to, device management software.

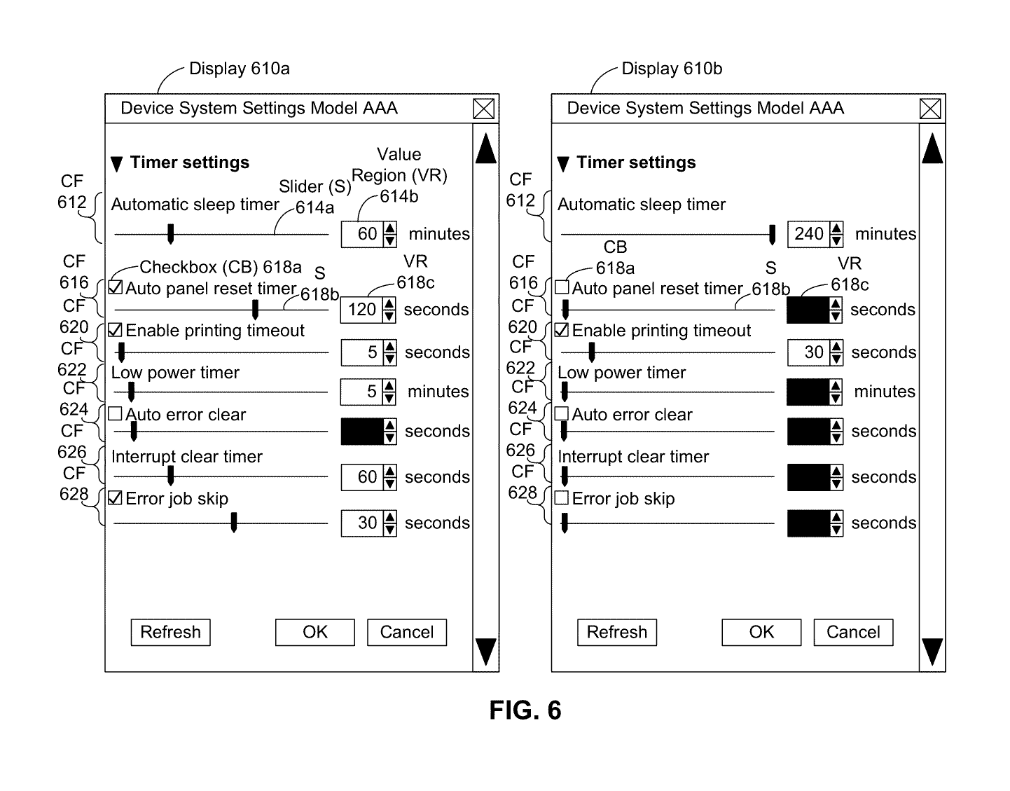

FIG. 6 shows device settings dialog as displays 610a, 610b according to an example embodiment. Displays 610a, 610b can be for a printing device having model name “Model AAA”, such as printing device 110 as illustrated in FIGS. 3A and 4. Both displays 610a and 610b have several control fields related to printing device 110, including automatic sleep timer control field 612, auto panel reset timer control field 616, enable printing timeout control field 520, low power timer control field 622, auto error clear control field 624, interrupt clear timer control field 626, and error job skip control field 628.

Each control field of displays 610a, 610b can have one or more controls related to a printing device parameter. For example, control field 612 for an automatic sleep timer parameter of printing device 110 can include a slider (S) 614a and a value region 614b. A user of display 610 can review and/or change values of the automatic sleep timer parameter using slider 614a and/or value region 614b. As another example, control field 616 for auto panel reset timer parameter of printing device 616 has checkbox (CB) 618a, slider 618b, and value region 618c. Checkbox 618a can be used to indicate whether or not the auto panel reset timer parameter should be used—if a check is shown in checkbox 618a, then printing device 110 should use the auto panel reset timer parameter, and if a check is not shown in checkbox 618a, then printing device 110 should not use the auto panel reset timer parameter.

In display 610a, checkbox 618a is shown with a check to indicate printing device 110 should use the auto panel reset timer parameter and slider 618b and value region 618c indicate that a value of the auto panel reset timer parameter is set to 120 seconds. However, in display 610b, checkbox 618a is shown without a check to indicate printing device 110 should not use the auto panel reset timer parameter and slider 618b and value region 618c indicate that the auto panel reset timer parameter has a zero (or null) value, by having slider 618b of display 610b moved to the far left of its range indicating a minimum value, and having value region 618c of display 610b blacked out.

In contrast to display 610b, display 610a shows slider 618b at slightly more than halfway in its possible range and value region 618c with a specific 120 second value for the auto panel reset timer parameter. FIG. 6 also shows display 610a indicating that the enable printing timeout and error job skip parameters also are to be used by printing device 110, while display 610b indicates that only the enable printing timeout parameter is to be used by printing device 100.

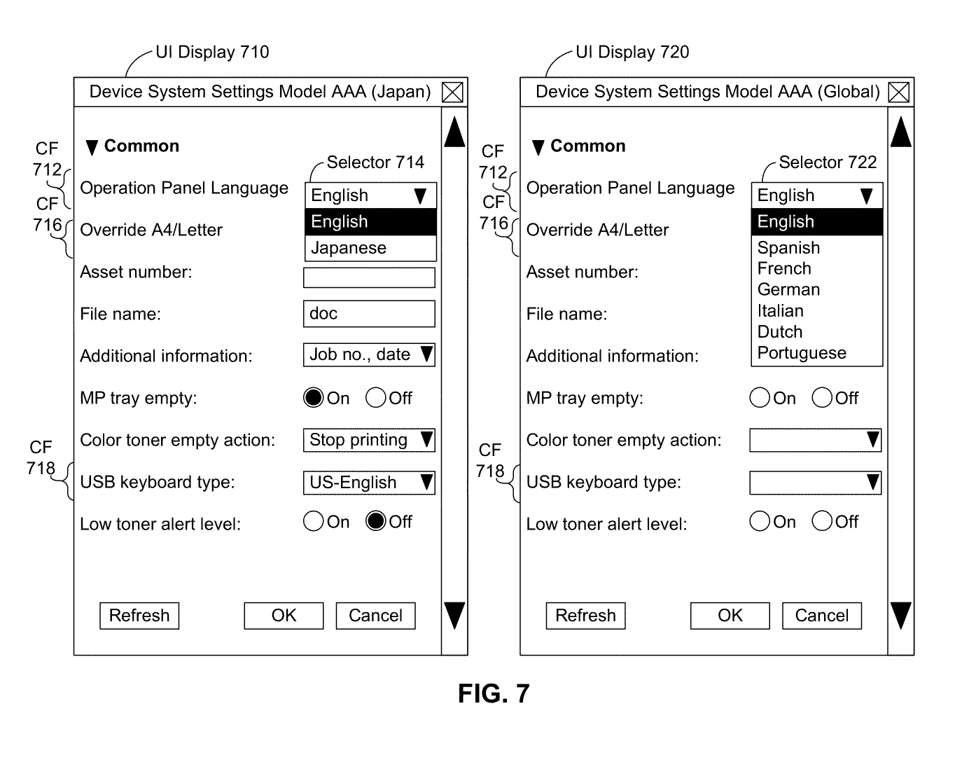

FIG. 7 shows example nation-specific and international device settings dialogs as UI displays 710 and 720, according to an example embodiment. Each of UI displays 710 and 720 include control fields for “Common” settings including an operation panel language setting, an “Override A4/Letter” setting, an asset number setting, a file name setting, an “Additional Information” setting, an MP tray empty setting, a color toner empty action setting, a USB keyboard type setting, and a low-toner alert level setting.

UI display 710 is a device settings dialog for a particular market; e.g., a Japanese-language market. In particular control field 712 for an “Operation Panel Language” has selector 714 to select between two languages: English and Japanese. Default and/or other values of control fields can be affected by the selection made via selector 714. For example, a selection for “English” made via selector 714 could lead to a default selection of “Off” for “Override A4/Letter” control field 716 (indicating that a document selected to be printed on letter-sized paper should not be printed on A4-sized paper without user selection), and/or a default selection of “US-English” for “USB keyboard type” control field 718. Similar interactions between other control fields of UI display 710 are possible as well.

UI display 720 is a device settings dialog for a global market. In particular control field 712 for an “Operation Panel Language” has selector 722 to select between at least seven languages: English, Spanish, French, German, Italian, Dutch, and Portuguese. Default and/or other values of control fields, such as control fields 716 and 718 of UI display 720 can be affected by the selection made via selector 722, such as discussed above in the context of select 714 of UI display 710. Similar interactions between other control fields of UI display 720 are possible as well.

V. Example Methods of Operation

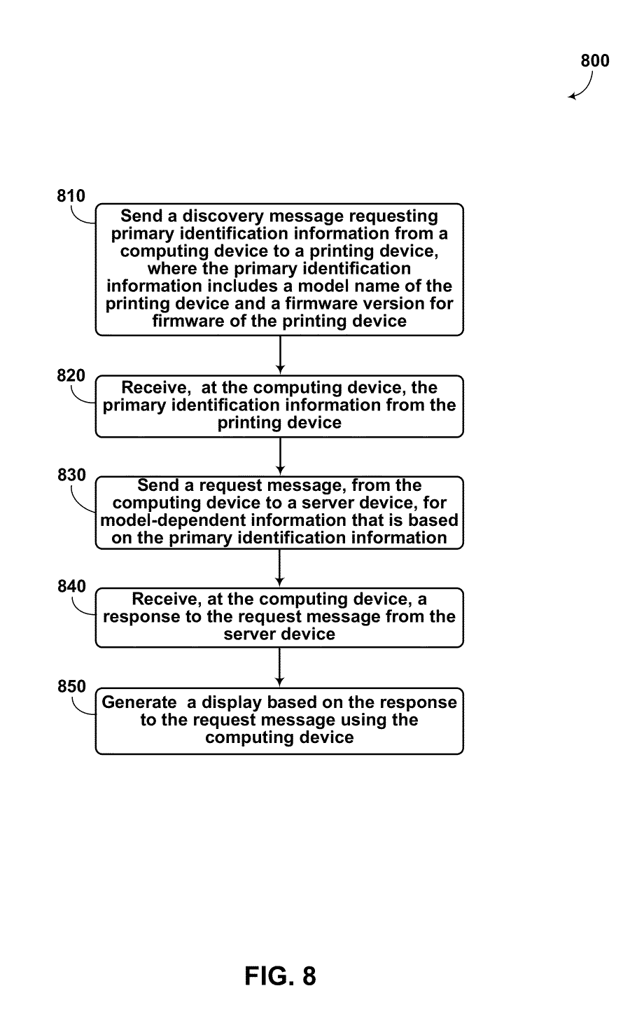

FIG. 8 is a flow diagram illustrating method 800, according to an example embodiment. Method 800 is a method for generating a display of model-dependent information that can be executed, at least in part, by a computing device executing device management software, such as device manager 220 discussed above in the context of at least FIG. 2A.

Method 800 can begin at block 810, where a computing device can send a discovery message requesting primary identification information to a printing device. The primary identification information can include a model name of the printing device and a firmware version for firmware of the printing device. In some embodiments, the primary identification information can further include one or more of: identifying information for the printing device, identifying information for a manufacturer of the printing device, and information about a physical location of the printing device.

At block 820, the computing device can receive the primary identification information from the printing device.

At block 830, the computing device can send a request message for model-dependent information to a server device, where the request message is based on the primary identification information. In some embodiments, the model-dependent information can include one or more of: information about hardware of the printing device, information about one or more printing characteristics of the printing device, information about one or more timers associated with the printing device, information about a function list for the printing device, and information related to printing device error messages. In particular embodiments, the function list can include at least one function that has at least one parameter.

In other embodiments, the model-dependent information can include information about a hardware configuration of the printing device. In some of the other embodiments, the hardware configuration of the printing device can specify at least one of: a number of printer trays for the printing device and a type of panel for the printing device. In still other embodiments, the model-dependent information about the printing device is based on the firmware version.

At block 840, the computing device can receive, at the computing device, a response to the request message from the server device.

At block 850, the computing device can generate a display based on the response to the request message. In some embodiments, generating the display can include generating a display that includes a function list and selecting a function of the function list. In particular embodiments, generating the display that includes the function list can include generating a display with one or more fields corresponding to one or more parameters of the selected function.

In some embodiments, method 800 can further include: determining one or more validation rules associated with the model-dependent information using the computing device; receiving additional model-dependent information via a user interface of the computing device; and validating the additional model-dependent information using the one or more validation rules using the computing device.

The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A system, comprising:
a computing device, comprising one or more processors and data storage, the data storage including at least computer-readable instructions for device management software, that, when the computer-readable instructions for the device management software are executed by the one or more processors, cause the computing device to perform device-management functions comprising:
send a discovery message requesting primary identification information to a printing device, wherein the primary identification information includes at least a model name of the printing device and a firmware version of the printing device;
receive, from the printing device, the primary identification information; and
send a request message for model-dependent information that is based on the primary identification information to a server device;
a server device, comprising one or more processors and data storage, the data storage including at least computer-readable instructions that when executed by the one or more processors, cause the server device to perform server-device functions comprising:
receive the request message; and
send a response to the request message to the computing device;
wherein the device-management functions further comprise:
receive the response to the request message; and
generate a display based on the response.

2. The system of claim 1, wherein generating the display comprises:
generating a display comprising a function list; and
receiving a selection of a selected function of the function list.

3. The system of claim 2, wherein generating the display comprising the function list further comprises:
generating a display with one or more fields corresponding to one or more parameters of the selected function.

4. The system of claim 1, wherein the primary identification information further includes one or more of: identifying information for the printing device, identifying information for a manufacturer of the printing device, and information about a physical location of the printing device.

5. The system of claim 1, wherein the model-dependent information includes one or more of: information about hardware of the printing device, information about one or more printing characteristics of the printing device, information about one or more timers associated with the printing device, information about a function list for the printing device, and information related to printing device error messages.

6. The system of claim 5, wherein the function list comprises at least one function that has at least one parameter.

7. The system of claim 1, wherein the model-dependent information includes information about a hardware configuration of the printing device.

8. The system of claim 7, wherein the hardware configuration of the printing device specifies at least one of: a number of printer trays for the printing device and a type of panel for the printing device.

9. The system of claim 1, wherein the model-dependent information about the printing device is based on the firmware version.

10. The system of claim 1, wherein the device-management functions further comprise:
determining one or more validation rules associated with the model-dependent information;
receiving additional model-dependent information via a user interface; and
validating the additional model-dependent information using the one or more validation rules.

11. A method, comprising:
sending a discovery message requesting primary identification information from a computing device to a printing device, wherein the primary identification information comprises at least a model name of the printing device and a firmware version for firmware of the printing device;
receiving, at the computing device, the primary identification information from the printing device;
sending a request message, from the computing device to a server device, for model-dependent information that is based on the primary identification information;
receiving, at the computing device, a response to the request message from the server device; and
generating a display based on the response to the request message using the computing device.

12. The method of claim 11, wherein generating the display comprises:
generating a display comprising a function list; and
receiving a selection of a selected function of the function list.

13. The method of claim 12, wherein generating the display comprising the function list further comprises:
generating a display with one or more fields corresponding to one or more parameters of the selected function.

14. The method of claim 11, wherein the primary identification information further includes one or more of: identifying information for the printing device, identifying information for a manufacturer of the printing device, and information about a physical location of the printing device.

15. The method of claim 11, wherein the model-dependent information includes one or more of: information about hardware of the printing device, information about one or more printing characteristics of the printing device, information about one or more timers associated with the printing device, information about a function list for the printing device, and information related to printing device error messages.

16. The system of claim 15, wherein the function list comprises at least one function that has at least one parameter.

17. The method of claim 11, wherein the model-dependent information includes information about a hardware configuration of the printing device.

18. The method of claim 17, wherein the hardware configuration of the printing device specifies at least one of: a number of printer trays for the printing device and a type of panel for the printing device.

19. The method of claim 11, wherein the model-dependent information about the printing device is based on the firmware version.

20. The method of claim 11, further comprising:
determining one or more validation rules associated with the model-dependent information using the computing device;
receiving additional model-dependent information via a user interface of the computing device; and
validating the additional model-dependent information using the one or more validation rules using the computing device.
